(19) United States
(12) Patent Application Publication
(10) Pub. No.: US 2012/0222578 A1
(43) Pub. Date: Sep. 6, 2012

(54) ABSORBENT FIBROUS WEB SUBSTRATES HAVING DISTINCT GRAPHICS AND METHOD FOR PRINTING SUBSTRATES

(76) Inventors: Alrick Vincent Warner, Loveland, OH (US); Kathryn Christian Kien, Cincinnati, OH (US); Kevin Benson McNeil, Loveland, OH (US)

(21) Appl. No.: 13/470,568

(22) Filed: May 14, 2012

Related U.S. Application Data
(62) Division of application No. 12/268,623, filed on Nov. 11, 2008.
Application No. 12/268,623 is a continuation-in-part of application No. 12/249,153, filed on Oct. 10, 2008.

(51) Int. Cl. B41F 3/02

(52) U.S. Cl. 101/483

(57) ABSTRACT

Fibrous web substrates and a process for printing a series of different graphics in the manufacture of fibrous web substrates, such as tissue and towel products, utilize flexographic printing with endless belts and have graphic repeats of at least about 58 inches. In addition, these substrates have color to color MD registration of less than about 1.5 mm.

### CROSS REFERENCE TO RELATED APPLICATION

This application is a divisional application of U.S. application Ser. No. 12/268,623, filed on Nov. 11, 2008, which claims the benefit of U.S. Non-Provisional application Ser. No. 12/249,153 filed Oct. 10, 2008.

### FIELD OF THE INVENTION

The present disclosure relates to methods for printing absorbent fibrous web substrates, and more particularly, methods for printing a series of different graphics on a plurality of absorbent fibrous web substrates as well as products including such substrates.

### BACKGROUND OF THE INVENTION

Some consumers may prefer absorbent fibrous web substrates with a number of different graphic designs printed thereon and provided in a single package. Various methods and apparatuses may be used to print different graphics on an advancing web of material used in the manufacture of facial tissue, bath tissue, and paper towels. However, such methods and apparatuses are limited. Existing methods often provide lower quality print and may require slower manufacture speeds and more expensive equipment. Therefore, existing methods may not provide low cost flexibility to vary the type of graphics to be printed on these web substrates.

In particular, one such process is flexographic printing that relies on the use of printing plates disposed on print cylinders. This type of process may restrict the number of different images that may be printed on the finished product, as well as restrict the ability to vary the distance between repeating images. Most flexographic printing plates have a fixed length. Printing cylinders, that have the plates mounted thereon, are also of a fixed diameter and circumference. Increasing the diameter of the printing cylinder to accommodate a larger number of plates, becomes impractical after a certain point. In addition, a printing plate does not allow the printing system to offer a multitude of different images. In order to change images, one must replace the printing plate or cylinder with another plate or cylinder, respectively, having different images. This change requires shutting down the equipment, substituting one plate or cylinder for another, and making a number of mechanical adjustments. Furthermore, these printing processes do not allow different images to be varied in size, location and registration as the pattern is repeated.

The disadvantages of the prior processes are minimized or avoided by the invention herein. Process advantages are provided, by feeding the fibrous web substrate onto a rotating central impression cylinder having an outer surface and arranging a plurality of printing stations adjacent to the outer surface of the central impression cylinder, wherein each printing station comprises an endless belt with one or more printing plates disposed thereon or integral with the endless belt. By advancing the endless belt to move each printing plate into contact with the fibrous web substrate, a plurality of different graphics may be printed on the substrate, thus maximizing the repeat of a series of graphics or images or otherwise varying these graphics.

### SUMMARY OF THE INVENTION

Embodiments of the methods and substrates disclosed herein utilize flexographic printing to provide a series of n fibrous web substrates having different graphics printed thereon.

Embodiments herein relate to an absorbent tissue product comprising a fibrous web substrate comprising a plurality of graphics, G1-Gn, wherein the graphics comprise a L_{REPEAT} SUBSTRATE of at least about 58 inches and an ink color disposed on the substrate in a non-random arrangement of dots wherein the color to color MD registration of the graphics is less than about 1.5 mm.

Embodiments herein further relate to a method for printing a fibrous web substrate comprising the steps of:
feeding the fibrous web substrate onto a rotating central impression cylinder having an outer surface;
arranging a plurality of printing stations adjacent to the outer surface of the central impression cylinder, wherein each printing station comprises an endless belt with one or more printing plates disposed on or integral to the endless belt; and
advancing the endless belt to move each printing plate into contact with the substrate whereby a plurality of graphics is printed on the substrate, wherein the graphics comprises a L_{REPEAT SUBSTRATE} of at least about 58 inches.

### BRIEF DESCRIPTION OF THE DRAWINGS

FIG. 1A is a first prior art printing machine.

FIG. 1B is a detailed view of a printing unit of the first prior art printing machine of 1A.

FIG. 1C is a second prior art printing machine.

FIG. 2 is a schematic view of printing apparatus according to the present disclosure.

FIG. 3A is a detailed schematic view of a printing station.

FIG. 3B is a partial detailed side view of an endless belt and associated printing plates.

FIG. 3C is a top side view of a printing plate from FIG. 3B.

FIG. 3D is a top view of a substrate with a sample series of graphics printed thereon.

FIG. 3E is a top view of a substrate with a sample series of graphics printed thereon.

FIG. 3F is a partial view of an endless belt with a plurality of printing plates arranged in the CD and MD directions.

FIG. 3G is a top view of a substrate with a sample series of graphics printed thereon.

FIG. 3H is a top view of a substrate with a sample series of graphics printed thereon.

FIG. 4 is a second embodiment of a printing apparatus including six printing stations.

FIG. 5 shows an example of ink dots utilized with halftone printing.

FIG. 6 shows an example of a cross-hair registration mark.

### DETAILED DESCRIPTION OF THE INVENTION

The following term may be useful in understanding the present disclosure: “Sanitary tissue product” or “tissue product” as used herein means a wiping implement for post-urinary and/or post-bowel movement cleaning (toilet tissue products), for otorhinolaryngological discharges (facial tissue products) and/or multi-functional absorbent and cleaning uses (absorbent towels such as paper towel products and/or wipe products). The sanitary tissue products of the present invention may comprise one or more fibrous web substrates and/or finished fibrous web substrates, traditionally, but not necessarily, comprising cellulose fibers. In one embodiment, the tissue products of the present invention include tissue-towel paper products.

A “tissue-towel paper product” refers to products comprising paper tissue or paper towel technology in general, including, but not limited to, conventional felt-pressed or conventional wet-pressed tissue paper, pattern densified tissue paper, starch substrates, and high bulk, uncompacted tissue paper. Non-limiting examples of tissue-towel paper products include paper towels, facial tissue, bath tissue, table napkins, and the like.

“Ply” or “Plies”, as used herein, means an individual fibrous web substrate or sheet of fibrous web substrate, optionally to be disposed in a substantially contiguous, face-to-face relationship with other plies, forming a multi-ply fibrous web substrate. It is also contemplated that a single fibrous web substrate can effectively form two “plies” or multiple “plies”, for example, by being folded on itself. In one embodiment, the ply has an end use as a tissue-towel paper product. A ply may comprise one or more wet-laid layers, air-laid layers, and/or combinations thereof. If more than one layer is used, it is not necessary for each layer to be made from the same fibrous web substrate. Further, the layers may or may not be homogenous within a layer. The actual makeup of a tissue paper ply is generally determined by the desired benefits of the final tissue-towel paper product, as would be known to one of skill in the art. The fibrous web substrate may comprise one or more plies of non-woven materials in addition to the wet-laid and/or air-laid plies.

The terms “fibrous web substrate” or “substrate” as used herein, mean an arrangement of fibers produced in any papermaking machine known in the art to create a ply of paper, in an embodiment an absorbent tissue product. “Fiber” means an elongate particulate having an apparent length greatly exceeding its apparent width. More specifically, and as used herein, fiber refers to such fibers suitable for a papermaking process.

The term “web substrate length” as used herein, means the length of the tissue product, taken in the MD, as sold to the consumer. For example, the web substrate length of a discrete napkin or placemat is the machine direction length of one napkin or placemat. The web substrate length of a roll of paper toweling or toilet tissue is the machine direction length of the entire roll, taken from the point of core attachment (if a core is present) or the inside end of the roll to the tail seal. In an embodiment the web substrate length for paper towel products or toilet tissue products comprises from about 400 inches to about 2,500 inches, and/or from about 500 inches to about 1,400 inches and/or from about 600 inches to about 1,200 inches.

The term “discrete sheet” means that portion of the fibrous web substrate which is discrete as defined by lines of termination. In an embodiment the discrete sheet may be a napkin or may be a single sheet of a rolled tissue or towel paper product with a plurality of discrete sheets. For example, a discrete sheet may have a length in the MD from about 4 inches to about 20 inches, and/or from about 8 inches to about 14 inches.

“Basis Weight”, as used herein, is the weight per unit area of a sample of the fibrous web substrate reported in lbs/3000 ft² or g/m².

“Machine Direction” or “MD”, as used herein, means the direction parallel to the flow of the fibrous web substrate through the converting machine and/or product manufacturing equipment.

“Cross Machine Direction” or “CD”, as used herein, means the direction perpendicular to the machine direction in the same plane of the fibrous web substrate.

The term “graphic” refers to images or designs that are constituted by a figure (e.g., a line(s)), a symbol or character, a color difference or transition of at least two colors, letters, words, characters, symbols, icons, or the like. A graphic may include an image or design, created by printing, that can provide certain benefit(s) when an absorbent fibrous web substrate is viewed.

### Single or Multi-Ply Fibrous Web Substrates

In one embodiment, the fibrous web substrate has a basis weight of from about 15 lbs/3000 ft² to about 50 lbs/3000 ft², and/or about 16 lbs/3000 ft² to about 40 lbs/3000 ft², and/or about 16 lbs/3000 ft² to about 37 lbs/3000 ft².

In one embodiment the fibrous web substrates may use of a variety of paper making fibers, such as, natural fibers, synthetic fibers, as well as any other suitable fibers, starches, and combinations thereof. Paper making fibers useful include cellulosic fibers commonly known as pulp fibers. Exemplary layering embodiments and processes of layering are disclosed in U.S. Pat. Nos. 3,994,771 and 4,300,981. In an embodiment, the fibrous web substrate may comprise any tissue-towel paper product known in the industry. Embodiment of these substrates may be made according U.S. Pat. No. 4,191,609 issued Mar. 4, 1980 to Trokhan; U.S. Pat. No. 4,300,981 issued to Carstens on Nov. 17, 1981; U.S. Pat. No. 4,191,609 issued to Trokhan on Mar. 4, 1980; U.S. Pat. No. 4,514,345 issued to Johnson et al. on Apr. 30, 1985; U.S. Pat. No. 4,528,239 issued to Trokhan on Jul. 9, 1985; U.S. Pat. No. 4,529,480 issued to Trokhan on Jul. 16, 1985; U.S. Pat. No. 4,637,859 issued to Trokhan on Jan. 20, 1987; U.S. Pat. No. 5,245,025 issued to Trokhan et al. on Sep. 14, 1993; U.S. Pat. No. 5,275,700 issued to Trokhan on Jan. 4, 1994; U.S. Pat. No. 5,328,565 issued to Rasch et al. on Jul. 12, 1994; U.S. Pat. No. 5,334,289 issued to Trokhan et al. on Aug. 2, 1994; U.S. Pat. No. 5,364,504 issued to Smurkowski et al. on Nov. 15, 1995; U.S. Pat. No. 5,527,428 issued to Trokhan et al. on Jun. 18, 1996; U.S. Pat. No. 5,556,509 issued to Trokhan et al. on Sep. 17, 1996; U.S. Pat. No. 5,628,876 issued to Ayers et al. on May 13, 1997; U.S. Pat. No. 5,629,052 issued to Trokhan et al. on May 13, 1997; U.S. Pat. No. 5,637,194 issued to Ampulski et al. on Jun. 10, 1997; U.S. Pat. No. 5,411,636 issued to Hermans et al. on May 2, 1995; EP 677612 published in the name of Wendt et al. on Oct. 18, 1995, and U.S. Patent Application 2004/0192136A1 published in the name of Gusky et al. on Sep. 30, 2004.

The substrates may be manufactured via a wet-laid making process where the resulting web is through-air-dried or conventionally dried. Optionally, the substrate may be foreshortened by creping or by wet microcontraction. Creping and/or wet microcontraction are disclosed in commonly assigned U.S. Pat. No. 6,048,938 issued to Neal et al. on Apr. 11, 2000; U.S. Pat. No. 5,942,085 issued to Neal et al. on Aug. 24, 1999; U.S. Pat. No. 5,865,950 issued to Vinson et al. on Feb. 2, 1999; U.S. Pat. No. 4,440,597 issued to Wells et al. on Apr. 3, 1984; U.S. Pat. No. 4,191,756 issued to Sawdai on May 4, 1980; and U.S. Pat. No. 6,187,138 issued to Neal et al. on Feb. 13, 2001. Conventionally pressed tissue paper and methods for making such paper are known in the art, for example U.S. Pat. No. 6,547,928 issued to Barnholtz et al. on Apr. 15, 2003. A suitable through air dried substrate may be made according to commonly assigned U.S. Pat. No. 4,191,609; U.S. Pat. No. 4,239,065, issued Dec. 16, 1980, Trokhan and U.S. Pat. No. 3,905,863, issued Sep. 16, 1975.

In one embodiment the tissue product is multi-ply, and the plies of the multi-ply fibrous web substrate may be the same substrate respectively or the plies may comprise different substrates combined to create desired consumer benefits. In one embodiment the fibrous web substrates comprise two plies of tissue substrate.

In one embodiment, the fibrous web substrate comprises a plurality of embossments. In one embodiment the embossment pattern is applied only to one ply. In another embodiment the fibrous web substrate is a two ply product wherein both plies comprise a plurality of embossments. In one embodiment the fibrous web structure comprises two or more plies of fibrous web substrate wherein at least one of the piles has a plurality of embossments thereon.

Suitable means of embossing include those disclosed in U.S. Pat. No. 3,323,983 issued to Palmer on Sep. 8, 1964; U.S. Pat. No. 5,468,323 issued to McNeil on Nov. 21, 1995; U.S. Pat. No. 5,693,406 issued to Wegele et al. on Dec. 2, 1997; U.S. Pat. No. 5,972,466 issued to Trokhan on Oct. 26, 1999; U.S. Pat. No. 6,030,690 issued to McNeil et al. on Feb. 29, 2000; and U.S. Pat. No. 6,086,715 issued to McNeil on Jul. 11, 2000.

The fibrous web substrate may be in any suitable form, such as in a roll form (e.g. wound about a core or may be wound without a core), in individual sheets, in connected, but perforated sheets, and/or in a folded or unfolded format.

Aspects of the present disclosure involve fibrous web substrates and methods for printing fibrous web substrates, and more particularly, for printing a series of different graphics during the manufacture of fibrous web substrates.

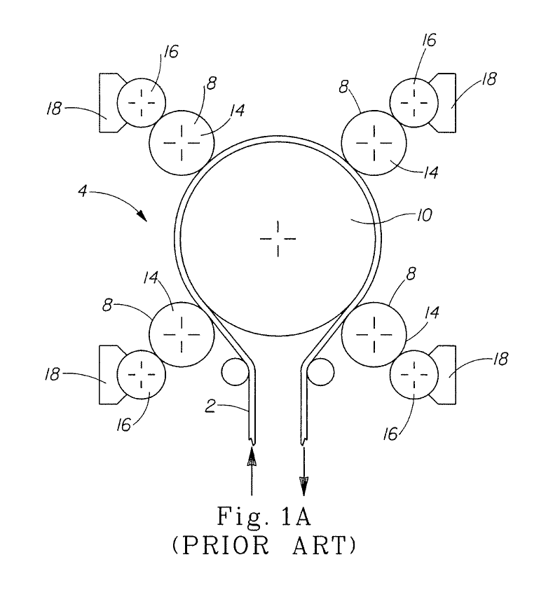

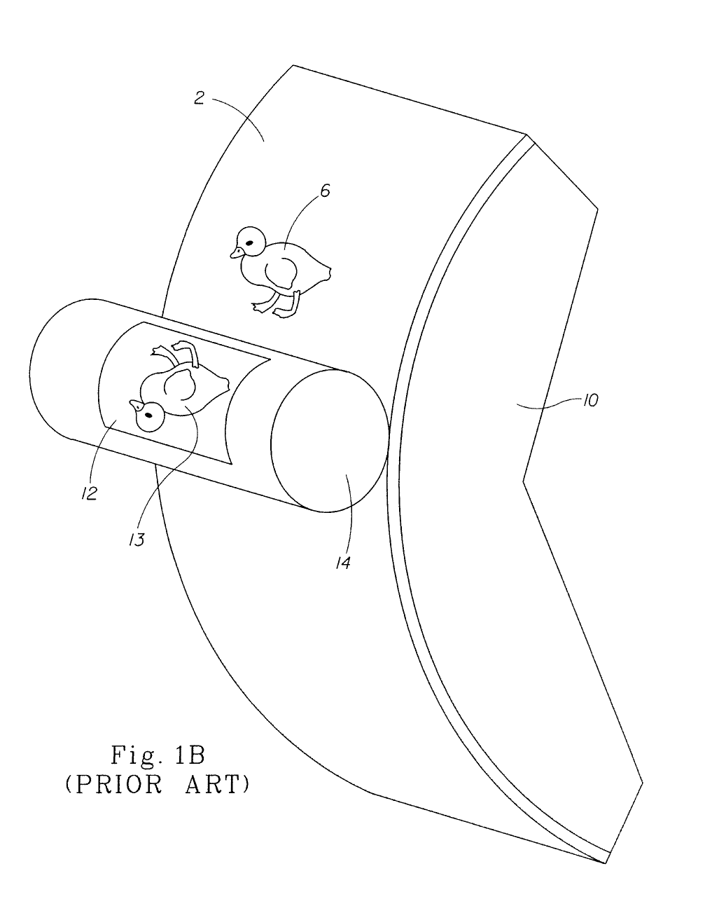

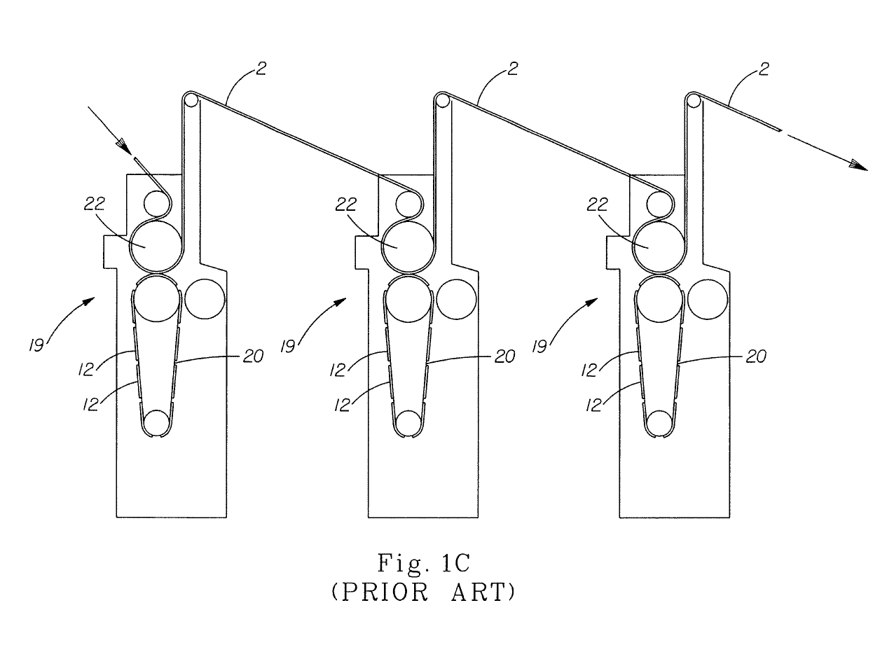

In existing conventional flexographic printing machines, such as shown in FIGS. 1A and 1B, a web 2 is fed into the printing machine 4 and an image 6 is printed as the web is advanced through a series of print units 8 disposed around a central impression cylinder 10. Each print unit 8 may include a print plate 12 connected with the outer surface of a print cylinder 14. The print plate includes images 13 of the graphics to be printed. The print stations also include an anilox roll 16, which applies ink from an ink pan 18 to the print plate 12. During the printing process, the central impression cylinder 10, the print cylinder 14, and anilox roll 16 all rotate, and the print plate 12 contacts the web 2 to transfer the ink from the graphic images 13 on the print plate 12 to the web thereby printing the graphics 6 thereon. A disadvantage of this system is that the diameter of the print cylinder 14 may become prohibitively large depending on the number of print plates 12 to be added to the print cylinder 14. Alternatively, placing relatively smaller print plates on the print cylinder may increase the number of possible images, but the size of the printed image may be much smaller than what is desired. As such, the system of FIG. 1A may be limited to printing a series of only two or three different graphics, may be relatively expensive, and may require complete removal and replacement of print cylinders when being reconfigured to print different graphics and/or sizes.

Also, existing printing machines may include a series of flexographic printing units, such as those described in U.S. Pat. Nos. 4,856,429 and 5,003,873. For example, FIG. 1C shows print units 19 arranged in a series to print various graphics. The print units 19 are each configured with a belt 20 having a plurality of print plates 12 disposed thereon. In addition, each print unit includes an impression cylinder 22, and a dryer (not shown). During the printing process, the belt 20 moves the print plates 12 into contact with the web 2 on the respective impression cylinders 22 as the web 2 is advanced from print unit 19 to print unit 19. However, as shown in FIG. 1C, as the web 2 travels, it is subjected to free space after each print unit wherein it is not held against a fixed surface. As such, speed mismatches and heating under tension between the print unit components may cause the web to stretch, and may result in graphics being printed in undesired locations, e.g. misregistered, along the web. In addition, each print unit includes a separate impression cylinder, which may add to the equipment and maintenance costs.

An embodiment of the present invention relates to method of printing a fibrous web substrate, wherein a substrate is fed in the MD onto a rotating central impression cylinder of the printing apparatus having a plurality of printing stations disposed about the outer surface of the central impression cylinder. Each printing station may include n printing plates disposed on an endless belt and each is adapted to print a series of n graphics (G1-Gn) in the MD on the substrate. The printing stations may also be configured for halftone printing and configured to print different colors. In a second step, the substrate is moved past each printing station on the rotating central impression cylinder. In a third step, ink is transferred from the printing plates on the endless belts to the substrate. In an embodiment, the ink is transferred from each printing station to the substrate in a non-random arrangement of dot, e.g. substantially equally spaced dots of ink or rows of dots. For example, the ink will be disposed on the substrate in rows of dots resulting from or corresponding to the screen pattern over the print plate, wherein the screen pattern comprises a defined number of lines (or straight lines of dots) per inch. In an embodiment the rows of dots may be seen using about 20× to about 30×magnification with a microscope. The dots may be of various shapes and sizes, e.g. round, square, hexagon, elliptical, etc. In addition, the rows of dots from screen patterns of the anilox roll at each printing station may be printed at different screen angles so the graphics appear in different colors. In some embodiments, four printing stations are configured to print cyan, magenta, yellow, and black colors at screen angles of 15°, 75°, 0° or 90°, 45°, respectively. Thereafter, one or more, of the series of n absorbent fibrous web substrates are rolled, folded, stacked, and placed in a package.

In one embodiment, the substrate traveling in the MD is fed onto a rotating central impression cylinder or drum of a flexographic printing apparatus. Printing stations are located around a portion of the outer circumference of the central impression cylinder. While disposed on the rotating central impression cylinder, the substrate moves past the printing stations, which in turn, print a series of n graphics (G1-Gn), which may repeat, on the substrate, wherein each of the n graphics is different from each other, wherein n can be a number of 2 or greater and in another embodiment, n can be a number of 5, 10, 12, or 24 or greater. Lines of termination may be added to the advancing substrate to form discrete sheets. Thus, a product may be manufactured by rolling, folding, stacking, and placing one or more, or a portion of, the series of n fibrous web substrates in a package.

In an embodiment, each printing station of the printing apparatus may include an endless belt drawn around a printing roller. A plurality of flexible printing plates may be disposed on the endless belt, wherein each flexible printing plate may include a different graphic pattern corresponding to a distinct graphic to be printed on the substrate. As the central impression cylinder rotates, the substrate is advanced into a nip between the central impression cylinder and each printing station. At the same time, rotation of the central impression cylinder advances the endless belt and associated printing plates into contact with the substrate. More particularly, a first printing plate moves into contact with the substrate to print a first associated graphic onto the substrate. As the central impression cylinder continues to rotate, the substrate continues to move past the printing station, and the endless belt advances a second printing plate into contact with the substrate to print a second associated graphic onto the substrate. The central impression cylinder continues to rotate and the endless belt continuously advances such that all n printing plates disposed on the endless belt print associated graphics onto the substrate. As a result, a series of n graphics (G_{1-G}ₙ) is printed on the substrate, wherein each of the n graphics may be different from each other. Once all n graphics are printed on the substrate, the endless belt advances to the first printing plate into contact with the substrate again and continues to repeatedly print the series of graphics. As discussed below, the printing stations can be configured in various ways to print different colored graphics. For example, in one embodiment, the printing stations may be configured to print graphics on a substrate through a process of halftone process printing.

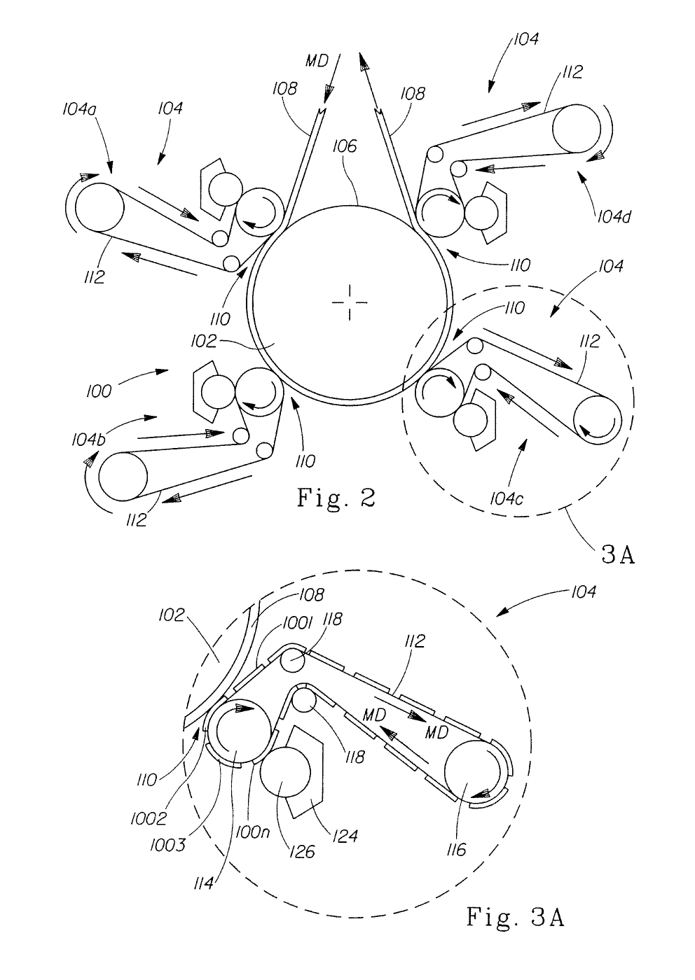

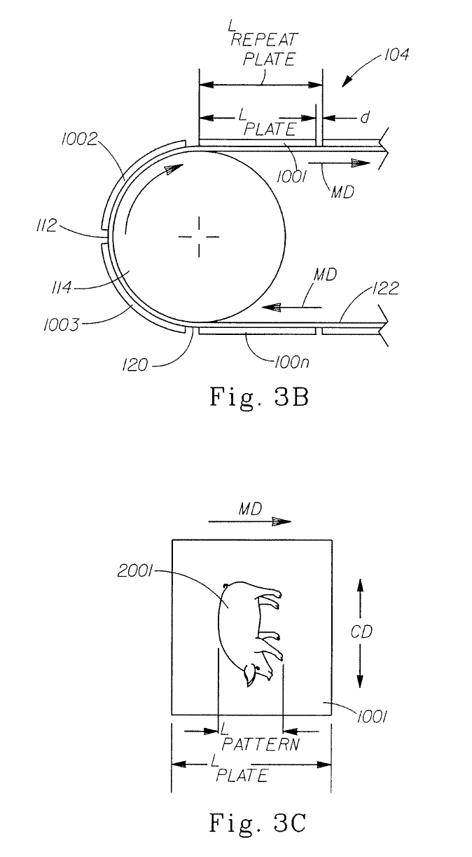

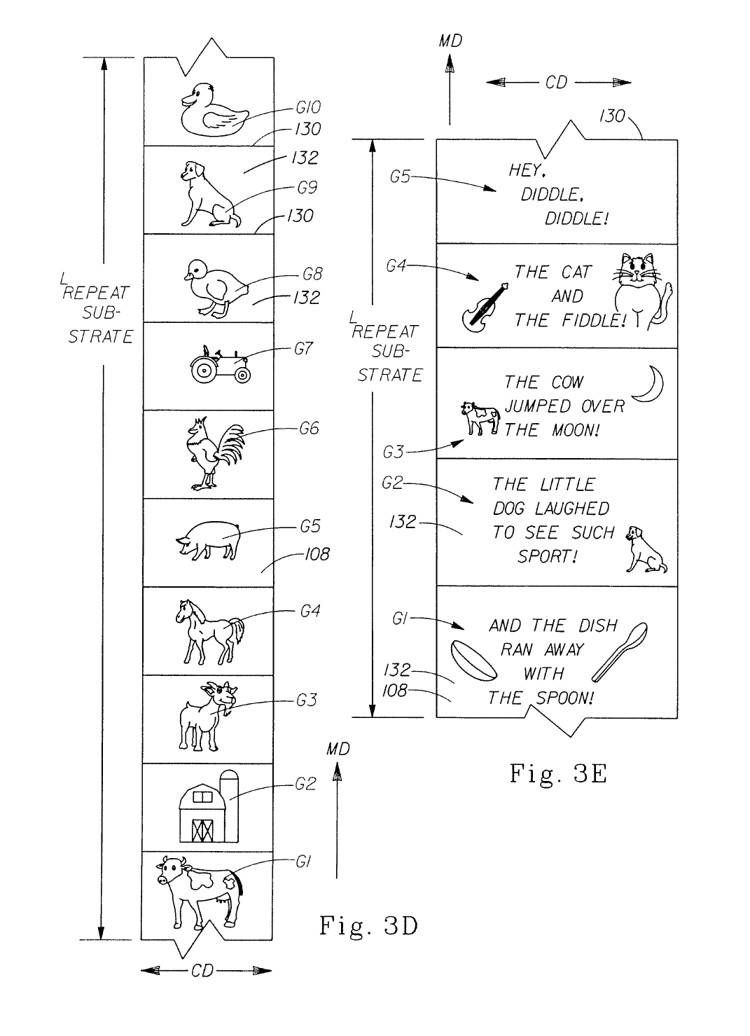

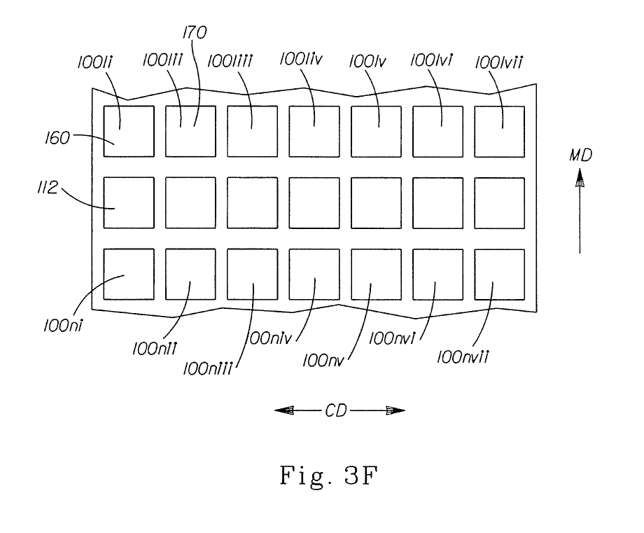

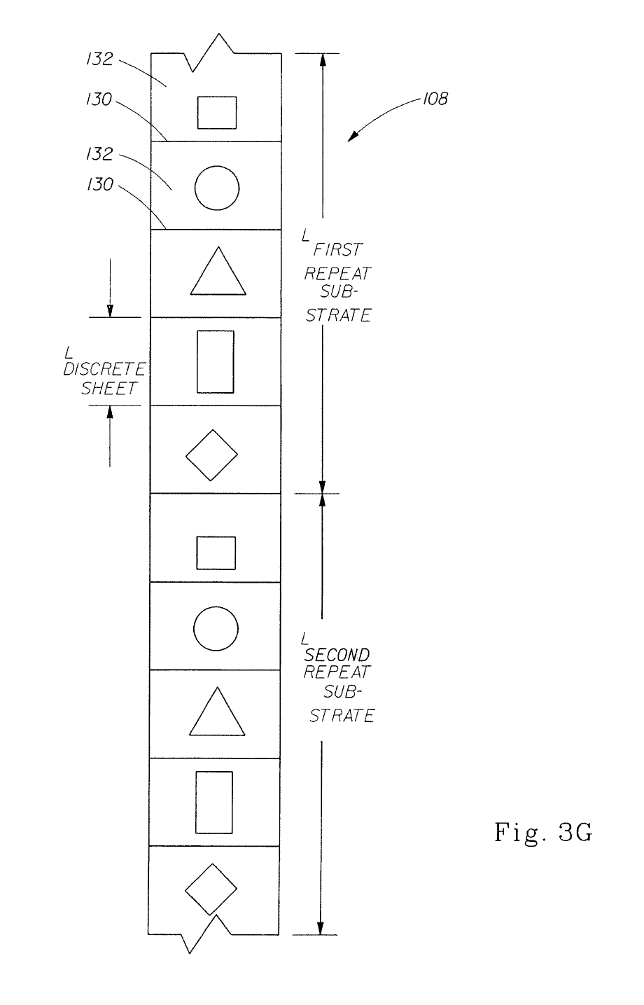

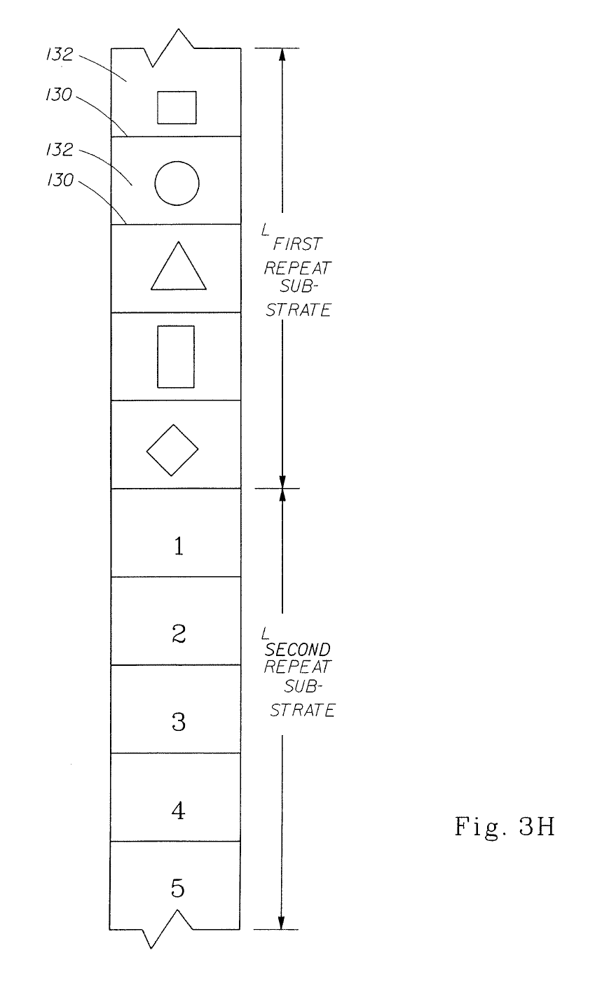

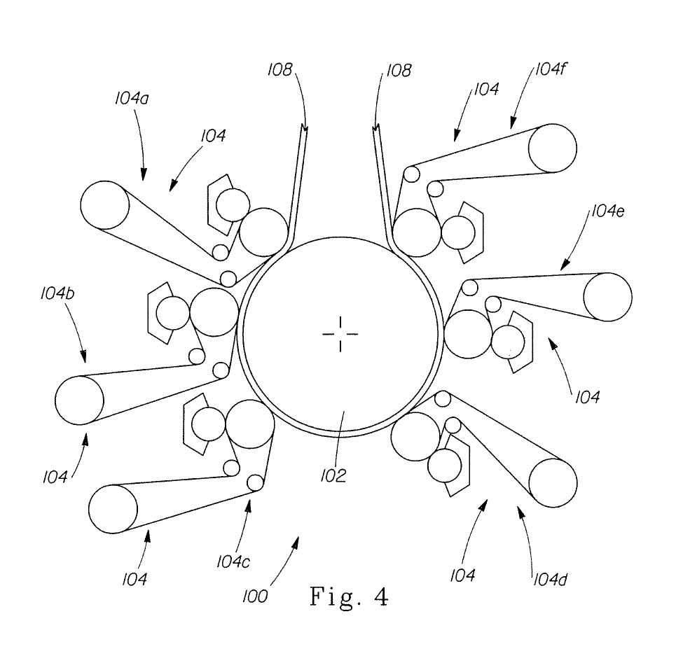

FIG. 2 shows an embodiment of a printing apparatus 100 conforming to aspects of the present disclosure. As shown in FIG. 2, the printing apparatus 100 includes a central impression cylinder (CIC) or CI drum 102 and a plurality of printing stations 104 disposed along an outer surface 106 of the central impression cylinder 102. FIGS. 3A-3C show a detailed view of an embodiment of the printing station 104 and embodiments of various components associated therewith. Although the printing apparatus 100 shown in FIG. 2 includes four printing stations 104, it is to be appreciated that other embodiments may include more or less than four printing stations. For example, FIG. 4 shows a printing apparatus 100 including six printing stations 104.

Referring back to FIG. 2, in operation, the central impression cylinder 102 rotates in the direction shown and a substrate 108 is fed onto the rotating central impression cylinder 102, which moves past each printing station 104 and exits the printing apparatus. As the substrate 108 moves past the printing stations 104, the printing stations 104 print a series of graphics (G₁-Gₙ) onto the substrate 108. As discussed in more detail below, some components of the printing stations 104 are located relatively close to the outer surface (or the outer circumferential surface) 106 of the central impression cylinder 102 so as to create a nip 110 between each printing station 104 and the central impression cylinder 102. The nips 110 help maintain the substrate 108 in a constant or fixed position relative to the outer surface 106 of central impression cylinder 102, which in turn, helps provide print and color registration control.

As previously mentioned, the printing stations 104 can be configured to print a series of different graphics, which may repeat, on the substrate. As shown in FIGS. 2-3B, each printing station 104 includes an endless belt 112 with a plurality of flexible printing plates or printing plates (1001-100n) disposed thereon. In turn, the endless belt 112 is drawn around a first printing roller 114 and a second printing roller 116. As shown in FIG. 3A, the printing station 104 may also include one or more belt tensioning rollers 118 operably connected with endless belt 112 to help maintain a desired belt tension. The endless belt 112 has a first surface (or outer surface) 120 and a second surface (or inner surface) 122 opposite the first surface, wherein the printing plates (1001-100n) are disposed on the first surface 120 and wherein the second surface 122 is in contact with the first and second printing rollers 114, 116. As discussed in more detail below, the printing plates (1001-100n) may include printing patterns (2001-200n) that are different from each other. During operation, the central impression cylinder 102 rotates and causes, via coupled drive means known in the art, the endless belt 112 to advance and rotate the first and second printing rollers 114, 116. Alternatively, separate drive means may be used to rotate the central impression cylinder 102 and the endless belt 112 in synchronization. As the endless belt 112 advances, the printing plates on the endless belt move into contact with the substrate 108 disposed on the rotating central impression drum 102. As discussed below, as the printing plates 1001-100n move into contact with the substrate 108, ink on the printing patterns 2001-200n is transferred to the substrate 108.

It is to be appreciated that the printing stations 104 may include different types of endless belt 112 configurations. For example, some embodiments may include a dimensionally stable endless belt made from a polyester film. In a particular example, the endless belt may be about 0.25 mm thick and may be made from polyethylene terephthalate. The physical properties of the transversely and longitudinally stretched film material may be the same in all directions. Such uniformity may extend over a wide temperature and humidity range. In addition, the film belt material may have relatively high elongation and impact resistance in transverse and longitudinal directions. Further, the film material of the endless belt may also be chemically resistant to withstand oils, greases, printing inks, and the like. In some embodiments, the endless belts may be provided with perforations adjacent the longitudinal edges of the endless belt. In such a configuration, knobs or teeth protruding from the first and second print rollers may be adapted to engage the perforations to help prevent the endless belt from sliding on the printing rollers.

As shown in FIG. 3A, each printing station 104 may also include an ink supply 124 and an anilox roller 126, which is operably connected with the ink supply 124 and the endless belt 112. During operation of the printing apparatus 100, the anilox roller 126 rotates and deposits ink from the ink supply 124 onto the printing plates (1001-100n) on the moving endless belt 112. More particularly, the anilox roller 126 transfers ink onto printing patterns (2001-200n) on the printing plates (1001-100n) as the printing plates move past the anilox roller. The printing stations 104 may also include a device to remove excess ink from the anilox roller. For example, in some embodiments, the printing stations include a doctor blade configured to scrape excess ink from the anilox roller 126 before transferring ink to the printing plates 1001-100n. As the endless belt 112 advances, the printing plates (1001-100n) move into contact with the substrate 108 on the central impression drum 102, and in turn, transfer ink from the printing patterns (2001-200n) on the printing plates to the substrate. Although not shown in FIG. 3A, it is to be appreciated that the printing stations 104 may also include ink driers. Driers located between printing stations may serve to partially dry the ink printed by a preceding print station, which may fix the ink from each preceding print station to the substrate and to help minimize ink smearing.

In an embodiment, the location of the anilox roller 126 and the ink supply 124 may be at any position around the endless belt 112 and in contact with the printing plates, as long as the endless belt 112 advances each printing plate (1001-100n) to sequentially moved into contact with the anilox roller 126, which transfers ink onto the printing patterns (2001-200n). In another embodiment the location of the anilox roller 126 and the ink supply 124 is adjacent to the position at which the endless belt 112 and the printing plates are adjacent to the second printing roller 116.

Various types and configurations of endless belts 112 and printing plates (1001-100n) may be used. For example, in some embodiments, the printing plates may be constructed from flexible photopolymer or rubber. The printing patterns (2001-200n) may be formed on the printing plates in various ways. For example, in some embodiments, the printing patterns are engraved into the printing plates. It should also be appreciated that the printing plates can be secured to the outer surface of the endless belt in various ways, such as with, for example, fasteners, adhesives, and tape. In some embodiments, the endless belts have printing patterns formed directly therein (e.g. the printing plates are integral to the endless belt). As previously mentioned, graphics are printed on the substrate when ink is transferred from the printing patterns to the substrate. As such, the CD width and MD length of the printed graphics can also be varied by varying the size of the printing patterns. For example, some embodiments can be configured to print graphics having a CD width of about 2.5 m or greater. In addition, some embodiments of printing stations can be configured with various numbers of printing plates or printing patterns, and as such, may accommodate different lengths of endless belts. For example, some printing stations can be configured to include an endless belt length of about 1.5 meters to about 4.5 meters or greater. The printing apparatus can also be configured to allow ease of removal and replacement of printing plates and/or endless belts, providing for relatively quick printing apparatus changeovers/reconfiguration for different print jobs.

In an embodiment, the printing apparatuses 100 may be configured to print a repeating series of n graphics (G1-Gn) on a substrate. In operation, the central impression cylinder 102 rotates in the direction shown for example in FIG. 2, and the substrate 108 is fed onto the rotating central impression cylinder 102. In turn, the substrate 108 moves past each printing station 104 as the central impression cylinder 102 rotates. As the substrate moves past the printing stations 104, the printing stations 104 print a series of graphics (G1-Gn) onto the substrate 108. More particularly, the rotation of the central impression cylinder 102 causes the endless belt 112 on each printing station 104 to advance. As the endless belt 112 advances, the first printing roller 114 and the second printing roller 116 rotate. As the endless belt advances 112, each printing plate (1001-100n) is sequentially moved into contact with the anilox roller 126, which transfers ink onto the printing patterns (2001-200n). At the same time, each printing plate (1001-100n) is sequentially moved into contact with the substrate 108 on the rotating central impression cylinder 102. Graphics (G1-Gn) are printed on the substrate 108 as ink from the printing patterns (2001-200n) on the printing plates (1001-100n) is transferred to the substrate 108. Thus, a repeating series of graphics are printed on the substrate 108 along the MD once each printing plate has been moved into contact with substrate. For example, printing stations having n printing plates (1001-100n) may print a repeating series of n graphics (G1-Gn) on the substrate. FIG. 3D shows an example of a substrate 108 printed with a repeating series of 10 graphics (G1-G10) in the MD having a repeat length of graphics on the substrate of L_{REPEAT SUBSTRATE}. FIG. 3E shows another example of a substrate 108 printed with a repeating series of graphics (G1-G5) in the MD having an L_{REPEAT SUBSTRATE} wherein each graphic illustrates a portion of a story. After graphic G5, the series may repeat again to illustrate the same story or may begin a series of graphics illustrating a different story, and so on. In an embodiment each graphic G1 to Gn is registered between lines of termination 130, and each discrete sheet 132 comprises a different graphic. Lines of termination are the lines separating the discrete sheets 132. The lines of termination 130 include perforations, chop off cuts, or other lines of weakness that allow separation of the discrete sheets 132. Perforations or other types of line of weakness are generally not completely separated at the time of manufacture, but are separated by the consumer prior to use. For example, the consumer may tear off a discrete sheet for use in household cleaning tasks. Chop off cuts separate discrete sheets from adjacent discrete sheets usually during manufacture, for example to form napkins. The lines of termination 130 shown in FIGS. 3D and 3E, in an embodiment, are oriented in the CD, however, lines of termination may also have diagonal orientation or other spaced relationship in the MD.

FIGS. 3G and 3H show other examples of a substrate 108 printed with a repeating series of graphics (G1-Gn) in the MD having a L_{FIRST REPEAT SUBSTRATE} and a L_{SECOND REPEAT SUBSTRATE}. A series of graphics repeat again to illustrate the same series of graphics, as in 3 G, or a different series of graphics, as in FIG. 3H. In an embodiment each graphic G1 to Gn is registered with the lines of termination 130, and each discrete sheet 132 comprises a different graphic. The discrete sheet 132 may have a length, L_{DISCRETE SHEET} in the MD, from about 4 inches to about 20 inches, and/or from about 8 inches to about 14 inches. L_{FIRST REPEAT SUBSTRATE} and a L_{SECOND REPEAT SUBSTRATE} may have the same length or different lengths.

In an embodiment, the graphics G1-Gn that form a L_{REPEAT SUBSTRATE} in the MD result from the use of about 1 printing plate or from a plurality of printing plates. In an embodiment, L_{REPEAT SUBSTRATE} is from about 58 inches to about 2,500 inches, or from about 59 inches to about 1,400 inches or from about 60 inches to about 1,400 inches. In another embodiment the L_{REPEAT SUBSTRATE} is at least about 58 inches, or at least about 60 inches, or at least about 65 inches.

As previously mentioned, components of the printing stations 104 may be located relatively close to the outer surface 106 of the central impression cylinder 102 so as to create nips 110 between the printing stations 104, the substrate 108, and central impression cylinder 102. In particular, the first printing roller 114 and the endless belt 112 disposed thereon can be located relatively close to the central impression cylinder 102 in order to form a nip 110 between the printing plates (1001-100n) on the endless belt 112 and the outer surface 106 of the central impression cylinder 102. In an embodiment, the printing stations 104 can be configured such that the distance between the printing plates and the central impression cylinder can be adjusted, which in turn, allows for adjustable nip pressures at each printing station. During operation of the printing apparatus, the substrate 108 is advanced into nips 110 between the central impression cylinder 102 and the printing stations 104. As the substrate 108 passes through the nips 110, the adjustable nip pressures help maintain the substrate in a constant or fixed position relative to the outer surface 106 of central impression cylinder 102. As such, the present method and apparatus provide relatively precise and consistent print registration as opposed to less precise registration obtained from flexographic inline printing presses, even though both systems utilize endless belts for printing.

For example, Table 1 shows MD and CD registration print data measured from low basis weight films (e.g. 20 grams per square meter) printed on a “Flexographic CI Printing Press” similar to that depicted in FIG. 1A and a “Flexographic Inline Printing Press” similar to that depicted in FIG. 1C. Similar registration values are found for absorbent fibrous web substrates with basis weights from about 15 to about 40 lbs/ft².

TABLE 1
Color-to-color Ink Registration Data

| | |
|---|---|
| Flexographic CI | Flexographic Inline |
| Printing Press | Printing Press |

| MD | CD | MD | CD |
|---|---|---|---|
| Registration | Registration | Registration | Registration |
| Mean = | Mean = | Mean = | Mean = |
| 0.073 mm | 0.106 mm | 1.98 mm | 0.60 mm |
| Std. Devn. = | Std. Devn. = | Std. Devn. = | Std. Devn. = |
| 0.08 mm | 0.079 mm | 0.41 mm | 0.27 mm |

For rolled products such as paper towels and toilet paper, which have substantial web substrate lengths, registration of graphics is more difficult to maintain throughout the entire length of the substrate. Rolled products have, for example, web substrate lengths of about 400 inches to about 2,500 inches, and/or about 500 inches to about 1,400 inches, and/or from about 600 inches to about 1,200 inches. Thus, cumulative registration error may be greater throughout the entire length of these substrates. Registration of graphics is also further complicated by the fact that the amount of stretch in these substrates may be relatively high, especially in lower density through air dried substrates, and may vary throughout their entire length or between parent rolls. Often, in some embodiments, for these types of substrates, multicolor images are provided by using a separate image for each of four colors, e.g., yellow, magenta, cyan, and, black. The four colors, or different colors, are printed in register on the substrate to form a single image on the web. As such, multi-color printing requires precise color-to-color (e.g. ink-to-ink) registration to achieve good image quality. When the print on a substrate is in register, then generally the plates, used at different printing stations, for example each printing station using a different color (such as cyan, magenta, yellow and black in the case of four color) line up closely and accurately on the printing press to produce a more clearly defined graphic. In an embodiment, the color to color MD registration required for acceptable and well defined color at the edges of the graphics is less than or equal to about 1.0 millimeters or less than about 0.5 millimeters in both the MD and CD directions. In tissue and towel paper products, in an embodiment, the color to color MD registration is less than about 1.5 mm, and/or from about 0.05 mm to about 1.5 mm, and/or from about 0.04 to about 1.3 mm.

In tissue and towel paper products, in an embodiment, it may also be desirable to register the graphics with lines of termination, wherein, for example, within a range of from about 0.05 inches to about 0.5 inches and/or from about 0.1 inch to about 0.8 inch, over one or more discrete sheets or over the entire web substrate length.

An embodiment herein relates to a method of registering lines of termination with printed graphics on a fibrous web substrate comprising the steps of:
transporting a fibrous web substrate in a first direction at a first velocity;
feeding the substrate onto a rotating central impression cylinder, having an outer surface;
arranging a plurality of printing stations adjacent to the outer surface of the central impression cylinder, wherein each printing station comprises an endless belt with one or more printing plates disposed on or integral to the endless belt;
advancing the endless belt around a first printing roller and a second printing roller, to move each printing plate into contact with the substrate whereby a plurality of graphics, Gn, is printed on the substrate, wherein the plurality of graphics, Gn, optionally comprises a L_{REPEAT SUBSTRATE} of at least about 58 inches, wherein the first printing roller and the second printing roller being movable in the first direction at a second velocity;
imparting a plurality of lines of termination to the substrate from a blade movable at a third velocity, the lines of termination forming discrete sheets, the lines of termination are spaced apart from the graphics at a predetermined distance; and
varying the first and second velocities relative to the third velocity to adjust or maintain the predetermined spacing.

The graphics and the lines of termination are disposed upon the fibrous web substrate relative to each other such that registration is created. In an embodiment the predetermined distance between the lines of termination and the graphics has a tolerance range within ±0.125 inches and in another example, a tolerance range within ±0.063 inches. In an embodiment one or more methods of registering the printed graphics to emboss, to sheet perforations, and/or registering to slitters (log saws) may be utilized. For example, U.S. Pat. No. 6,983,686, issued Jan. 10, 2006, Vaughn et al., relates to a process of registering printed images to emboss patterns.

FIG. 3B shows a detailed side view of a portion of a printing station 104 wherein a plurality of printing plates (1001-100n) are disposed on the endless belt 112. FIG. 3C shows a top side view of an embodiment of one printing plate 1001 shown in FIG. 3B. As shown in FIG. 3B, the printing plates (1001-100n) each define a length in the MD direction, L_{PLATE}, and each of the printing plates may also be separated from each other in the MD direction by a distance, d, wherein d may be equal to or greater than zero. The sum of L_{PLATE}, and the distance, d, defines a plate repeat length, L_{REPEAT PLATE}. L_{REPEAT SUBSTRATE} in an embodiment, corresponds to the length of substrate 108 in the MD that moves past a printing station 104 from the point at which a printing plate initially acts upon the substrate before a subsequent printing plate engages the substrate or to the point at which the same printing plate no longer acts upon the substrate. L_{REPEAT SUBSTRATE}, in an embodiment, also corresponds to the length of substrate 108 in the MD that moves past all printing plates corresponding to a specific printing station from the point at which the initial printing plate initially acts on the substrate to the point at which all printing plates from that same printing station have acted on the substrate. As discussed above, the printing plates (1001-100n) comprise respective printing patterns (2001-200n) that transfer ink to the substrate 108 to print graphics (G1-Gn) thereon. As shown in FIG. 3C, the printing patterns (2001-200n) may also define a length in the MD, L_{PATTERN}, which also may correspond to the length in the MD of the corresponding graphics (G1-Gn) printed on the substrate 108.

The printing stations 104 can be configured to accommodate different values of L_{REPEAT SUBSTRATE}, L_{REPEAT PLATE} and L_{PATTERN}. For example, the repeat length may be configured to be substantially equal to the MD length of a printed component. For example, embodiments configured to print graphics on a substrate used to manufacture printed paper towels or toilet paper, L_{REPEAT PLATE} may be about 3 inches to about 15 inches.

It should also be appreciated that in some embodiments L_{PATTERN} may be equal to L_{REPEAT SUBSTRATE} or L_{REPEAT PLATE}, and in other embodiments, the L_{PATTERN} may be less than L_{REPEAT SUBSTRATE} or L_{REPEAT PLATE}. As such, MD length defined by printed graphics may span the entire web substrate length of a product or may span a portion of the web substrate length of a product. It should also be appreciated that the patterns (2001-200n) may be located in different positions along the MD and/or CD directions of the printing plates (1001-100n). As such, graphics can be located in different positions along the MD length and CD width of a substrate. It should further be appreciated that one or more printing plates (1000-100n) may include more than one printing pattern (2001-200n). Thus, a plurality of graphics can be located in different positions along the MD length and CD width of a substrate.

The number, n, of graphics printed in a series on a substrate may be increased or decreased by increasing or decreasing, respectively, the number n of printing plates and associated printing patterns mounted on the endless belts. For example, each printing station may have from about 2 printing plates to about 10 or more printing plates in the MD direction. As such, for a given L_{REPEAT SUBSTRATE} and L_{REPEAT PLATE}, a relatively longer endless belt may be required to accommodate higher numbers of printing plates. Alternatively, a relatively shorter endless belt may be required to accommodate fewer printing plates. For example, a printing station may include 12 printing plates arranged to print four repeating series of three different graphics.

It should also be appreciated that the embodiments of the printing apparatuses can be configured with various CD widths. For example, in some embodiments, the CD width may be about 3 inches to about 120 inches. In still other embodiments, the CD width may be from about 90 inches to about 120 inches for parent rolls, from about 8 inches to about 14 inches for paper towels, and from about 3 inches to about 6 inches for toilet tissue. It should also be appreciated that the printing stations can also be configured to include various numbers and sizes of printing plates oriented along the CD width of the endless belt. For example, some embodiments can be configured with 5, 7, or more printing plates along the CD width of the endless belt. FIG. 3F illustrates a portion of an embodiment of an endless belt 112 configured with seven printing plates (1001i-1001vii) disposed along the CD width of the endless belt 112, and n printing plates arranged along the MD direction of the endless belt. In other words, the endless belt shown in FIG. 3F has seven lanes of printing plates disposed along the CD direction, wherein each lane includes n printing plates, and comprising at least 2 lanes, a first lane 160 and a second lane 170. Thus, depending on a particular configuration, the printing plates shown in FIG. 3F can print at least seven identical or different series of n graphics in the MD direction of a substrate, wherein each series of n graphics are arranged along the CD width of the substrate. For example, from about 2 to about 30, or from about 2 to about 20 printing plates or lanes may be arranged in the CD direction. In an embodiment the printing plates of the first lane 160 correspond to a L_{FIRST REPEAT SUBSTRATE} and the printing plates of the second lane 170 correspond to a L_{SECOND REPEAT SUBSTRATE}, and wherein the L_{FIRST REPEAT SUBSTRATE} and the L_{SECOND REPEAT SUBSTRATE} are substantially registered with the lines of termination of the discrete sheet.

As previously mentioned, embodiments of the printing apparatus can be configured to include various numbers of printing stations 104. For example, as shown in FIG. 2, the printing apparatus 100 includes four printing stations 104. In addition, the printing stations may utilize different types of ink as well as different colors. In one example, the printing apparatus may be configured for CMYK printing wherein a first printing station 104a is adapted to print cyan, a second printing station 104b is adapted to print magenta, a third printing station 104c is adapted to print yellow, and a fourth printing station 104d is adapted to print black. In another example, shown in FIG. 4, the printing apparatus 100 includes six printing stations 104. In such an arrangement, the printing apparatus 100 may be configured with a first printing station 104a adapted to print yellow, a second printing station 104b adapted to print magenta, a third printing station 104c adapted to print cyan, a fourth printing station 104d adapted to print black, a fifth printing station 104e adapted to print teal, and a sixth printing station 104f adapted to print purple. The different ink colors and types may be used in combination to print an entire graphic on the substrate. In some configurations, a single printing station may be used to print a unitary color graphic on the substrate.

The printing stations 104 may also be configured to print graphics on a substrate that may appear in a relatively large range of colors through various different processes, such as for example, halftone printing. Halftone printing utilizes equally spaced dots of ink to simulate a continuous tone. Various descriptions of halftone printing processes are discloses in U.S. Pat. Nos. 4,142,462; 5,205,211; 5,617,790; 7,126,724; as well as U.S. Patent Publication No. 20040160644 and PCT Publication No. WO98/06006A1.

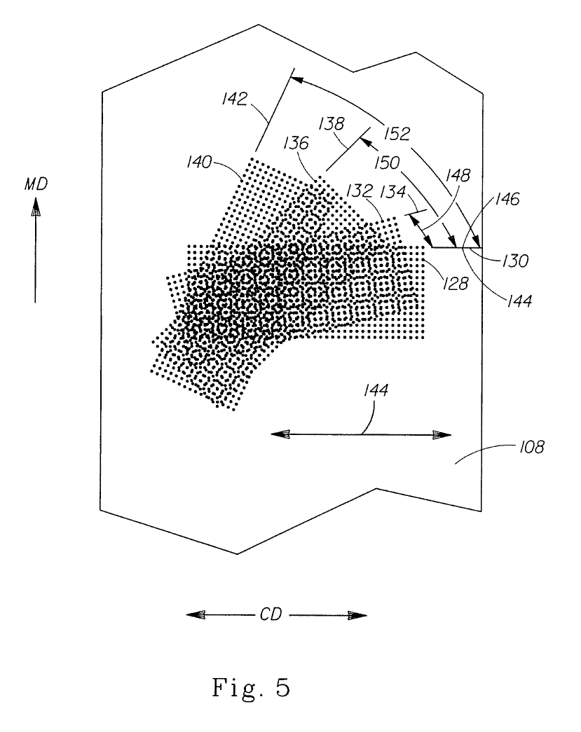

In one embodiment, the printing apparatus 100 shown in FIG. 2 may be configured for halftone printing. As such, the first, second, third, and fourth printing stations (104a-104d) may be configured to print cyan; magenta, yellow, and black colors, respectively. More particularly, the printing plates (1001-100n) on each printing station 104 are configured to print dots of ink of each respective color on the substrate. In addition, the printing plates (1001-100n) may be configured to print dots of various shapes, such as for example, round, elliptical, or square. Each printing station (104a-104d) may also be configured to print the dots in rows that extend along and/or parallel to respective axes. For example, with reference to FIGS. 2 and 5, the first printing station 104a may print rows of first color (e.g. cyan) dots 128 (or first rows of first dots 128) along or parallel to a first axis 130, the second printing station 104b may print rows of second color (e.g. magenta) dots 132 (or second rows of second dots 132) along or parallel to a second axis 134, the third print station 104c may print rows of third color (e.g. yellow) dots 136 (or third rows of third dots 136) along or parallel to a third axis 138, and the fourth print station 104d may print rows of fourth color (e.g. black) dots 140 (or fourth rows of fourth dots 140) along or parallel to a fourth axis 142. The substrate 108 comprises a non-random arrangement of dots 154, for example that correspond to the screen pattern over the print plate that comprises a defined number of lines per inch.

In halftone printing, the dot axes may be oriented at different angles, which may be referred to as screen angles, relative to a reference axis 144. As shown in FIG. 5, the first axis 130 may define a first screen angle 146, the second axis 134 may define a second screen angle 148, the third axis 136 may define a third screen angle 150, and the fourth axis 142 may define a fourth screen angle 152 relative to a reference axis. It is to be appreciated that various reference axes may be used as a basis for defining the screen angles. For example, the reference axis 144 shown in FIG. 5 is oriented in the CD direction on the substrate and is parallel to the first axis 130. In another example, the reference axis 144 may be oriented in the MD direction. In other examples, the reference angle may be parallel to any of the dot print axes. The resolution of halftone printing can be measured in lines per inch (lpi), which corresponds to the number of lines of dots in one inch as measured along a screen angle. It is to be appreciated that the printing apparatus can be configured to print various resolutions. For example, some embodiments can be configured to print line densities in the range of about 40 lpi to about 185 lpi or from about 45 lpi to about 85 lpi. It should also be appreciated that the printing apparatus can be configured to print dots at various screen angles. For example, the table below illustrates six examples of screen angles that may be used:

TABLE 4

| | Exam- | Exam- | Exam- | Exam- | Exam- | Exam- |
|---|---|---|---|---|---|---|
| | ple 1 | ple 2 | ple 3 | ple 4 | ple 5 | ple 6 |
| Ink | Screen | Screen | Screen | Screen | Screen | Screen |
| Color | Angles | Angles | Angles | Angles | Angles | Angles |
| Cyan | 112° | 105° | 15° | 75° | 105° | 15° |
| Magenta | 82° | 75° | 75° | 15° | 75° | 45° |
| Yellow | 97° | 0° or 90° | 0° or 90° | 0° | 90° | 0° |
| Black | 52° | 45° | 45° | 45° | 15° | 75° |

In operation, the printing stations may print dots at predetermined screen angles to produce graphics having desired colors. The dots printed by the printing stations may also be overlaid and may produce a pattern. In one example, the patterns may form a plurality of rosettes. In one embodiment, the printing stations are configured to produce open rosettes. In another embodiment, the printing stations are configured to produce closed rosettes. The dots may also be printed such that portions of subsequently printed dots overlap portions of previously printed dots to produce desired color combinations.

As discussed above, the printing stations 104 may be configured with n printing plates (1001-100n), wherein n may be 2 or greater and wherein the printing stations are configured to print different colors of ink. For the purposes of illustration with reference to the printing apparatus 100 shown in FIG. 2, the first print station 104a may be configured with n printing plates 1001a to 100na; the second print station 104b may be configured with n printing plates 1001b to 100nb; the third print station 104c may be configured with n printing plates 1001c to 100nc; and the fourth print station 104d may be configured with n printing plates 1001d to 100nd. In addition, the first printing station 104a may be configured to print a first color ink at a first screen angle 146; the second printing station 104b may be configured to print a second color ink at a second screen angle 148; the third printing station 104c may be configured to print a third color ink at a third screen angle 150; and the fourth printing station 140d may be configured to print a fourth color ink at a fourth screen angle 152. In some embodiments, the screen angles may be in accordance with those provided in Table 4. In addition, depending on the desired color combinations, portions of some ink dots printed by printing station may be printed to overlap portions of some ink dots printed by other printing stations. For example, the second printing station 104b may print dots of ink that overlap portions of dots of ink printed by first printing station 104a. In addition, the third printing station 104c may print dots of ink that overlap portions of dots of ink printed by the second printing station 104b and/or the first printing station 104a. Further, the fourth printing station 104d may print dots of ink that overlap portions of dots of ink printed by the third printing station 104c, the second printing station 104b, and/or the first printing station 104a.

In an embodiment during operation, the substrate 108 on the rotating central impression cylinder 102 moves past the printing stations (104a-104d), and printing plates 1001a, 1001b, 1001c, and 1001d to print ink on the substrate 108 to form a first graphic G1 on the substrate. In conjunction with the rotation of the central impression cylinder 102 and coordinated advancement of the endless belts 112 on the printing stations (104a-104d), printing plates 1002a, 1002b, 1002c, and 1002d print ink on the substrate to form a second graphic G2 on the substrate 108, wherein the first graphic G1 is adjacent the second graphic G2 in the MD (see for example FIGS. 3D and 3E). The process continues to advance printing plates 1003a, 1003b, 1003c, and 1003d to plates 100na, 100nb, 100nc, and 100nd resulting in a series of n graphics (G1-Gn) being printed on the substrate 108 in the MD. Once the nth graphic, Gn, is printed, the process is continuously repeated beginning again with plates 1001a, 1001b, 1001c, and 1001d through plates 100na, 100nb, 100nc, and 100nd, resulting in the series of n graphics (G1-Gn) being repeated along MD direction along a length of the substrate 108. As previously mentioned, the graphics G1 through Gn may be different from each other.

The printing apparatuses disclosed herein may also be configured to print at various speeds. For example, embodiments may be configured to print graphics on a substrate that allows the substrate to advance in the MD at a speed from about 1,500 to about 3,000 feet per minute.

For example, endless belts having multiple lanes of printing plates in the CD, and wherein the endless belts are from about 12 inches CD width to about 100 or even about 200 inches CD width, may accommodate manufacturing line speeds of about 300 to 2,500 feet per minute.

As previously mentioned, in some embodiments, the graphics G1-Gn on the absorbent fibrous web substrates are different from each other in terms of graphic design. Herein, “different in terms of graphic design” means that graphics are intended to be different when viewed by users or consumers with normal attentions. Thus, two graphics having a graphic difference(s) which are unintentionally caused due to a problem(s) or an error(s) in a manufacture process, for example, are not different from each other in terms of graphic design. The graphic design is determined by, for example, the color(s) used in the graphic (individual pure ink colors as well as built process colors), the sizes of the entire graphic (or components of the graphic), the positions of the graphic (or components of the graphic), the movements of the graphic (or components of the graphic), the geometrical shapes of the graphic (or components of the graphics), the number of colors in the graphic, the variations of the color combinations in the graphic, the number of graphics printed, the disappearance of color(s) in the graphic, and the contents of text messages in the graphic.

It should be appreciated that although a package may contain tissue or towel products which have the graphics G1-Gn different from each other, the package may also contain, if desired, one or more additional products which have a graphic that is the same as one the other graphics in the package. For example, the absorbent product may include at least n fibrous web substrates, in a series, which have the graphics G1-Gn different from each other, and can include an additional absorbent fibrous web substrate(s) each having the same graphic(s).

It should be appreciated that printed graphics may be permanent or active graphics. Active graphics are graphics that are configured to appear or disappear upon various types of triggering mechanisms or stimuli, such as for example, moisture (e.g. aquachromic ink graphics), temperature change (e.g. thermochromic ink graphics), pressure change, and/or light (e.g. photochromic ink graphics, UV or IR light).

It is also to be appreciated that the position of the graphics G1-Gn may be registered within a predetermined area of the absorbent fibrous web substrates such that each of the graphics G1-Gn appears in an intended position (or the predetermined area) in each absorbent fibrous web substrates without unintentional variation.

The graphics G1-Gn of the absorbent fibrous web substrates may also have a predetermined association. Herein, “association” refers to a relationship which can conceptually bond a plurality of graphics. The predetermined association may be formed by the graphic designs of the n graphics. The predetermined association may include a predetermined order and/or a common theme.

In some embodiments, the predetermined association includes a predetermined order, and the n fibrous web substrates are stacked or arranged in the package in accordance with the predetermined order. The predetermined order may include an order illustrating story, an order for daily activity, an order for educational training, an order for sequential indication, an order of usage instruction, an order illustrating child care tips, and an order of sales promotion. In some embodiments, each fibrous web substrate carries one step or stage in a predetermined order in the graphic, and the predetermined order is completed by the n graphics of the n fibrous web substrates. In embodiments where the graphics illustrate a story, the story may include a children's story and a cartoon story such as Aesop's Fables, nursery rhymes, and the like. In some embodiments, a product may include fibrous web substrates in a single package wherein each fibrous web substrate including graphics illustrating different stories or nursery rhymes. For example, a fibrous web substrate may include a graphic G1 illustrating a first nursery rhyme, such as Jack and Jill, and an adjacent fibrous web substrate in the package may include a graphic G2 illustrating a second nursery rhyme, such as the Cat and the Fiddle, and so on up to graphic Gn. In some embodiments, a product may include fibrous web substrates in a single package wherein each product may include portions of stories or nursery rhymes. For example and as discussed above with reference FIG. 3E, a fibrous web substrate in the package may include a graphic G1 illustrating a first portion of a first nursery rhyme, such as “Hey, Diddle, Diddle!”, and an adjacent fibrous web substrate may include a graphic G2 illustrating a second portion of the first nursery rhyme, such as “The Cat and the Fiddle!” and a next adjacent fibrous web substrate may include a graphic G3 illustrating a third portion of the first nursery rhyme, such as “The Cow Jumped over the Moon!”, continuing until the nursery rhyme is completed. Additional fibrous web substrates in the package may have graphics that repeat the first nursery rhyme or may include graphics that illustrate portions of other nursery rhymes. The order for daily activity may include, for example, eating foods, wearing (or changing) clothes, taking a bath, a toilet activity, making an object, cooking a food, sleeping, and growing a plant. For example, when changing clothes, the fibrous web substrate may have a graphic G1 which shows the first step of changing clothes (e.g., taking off a pair of pajamas), the absorbent fibrous web substrate may have a graphic G2 which shows the second step (e.g., taking off a used underwear), the fibrous web substrate may further have a graphic G3 which shows the third step (e.g., putting on a clean underwear), and the like. In addition, the order for daily activity may be shown together with preferred times for such activities in the graphics G1-Gn (e.g., 8:00 PM for sleeping). The order for educational training may include, for example, a puzzle or quiz on mathematics, characters (e.g., numbers and letters) which are decorated or undecorated, shapes of goods, combinations of colors, and a pattern recognition for intelligence development. The order for sequential indication may include, for example, a sequential symbol. The sequential symbol may indicate the number of the remaining fibrous web substrates in the package when the fibrous web substrates are consumed. Any sequential symbol including numbers (e.g., 1-60) and letters (e.g., A-Z) can be used. Such numbers and letters can also be used as an educational tool for kids. The order of usage instruction can include any information for users to effectively use fibrous web substrates. The order for child care tips can include any information for users (or care givers) to effectively take care of babies or children. The order for sales promotion can include any information for effectively advertising the absorbent fibrous web substrates to consumers. In an embodiment, the graphic sequence may be phased with the roll winding or sheet stacking operation such that the beginning graphic in the sequence is presented on the first sheet on the roll or in the stack to be used by the consumer. Therefore, in an embodiment the fibrous web substrate further comprises a plurality of discrete sheets separated by lines of termination, wherein the graphics are substantially registered to the lines of termination, and the predetermined order begins with the first discrete sheet used by the consumer.

In some embodiments, the predetermined association may include a common theme, and the n fibrous web substrates may be stacked or sequenced in the package in a randomly selected order. The common theme can be any theme which is consistently expressed in the n graphics. The common theme may include cartoon characters (e.g., one cartoon character is doing different activities such as playing, eating, taking a bath, and the like, or a plurality of different cartoon characters are doing same/different activities), transportation means (e.g., cars, trains, ship, planes, etc.), animals (e.g., dogs, cats, rabbits, etc.), fruits (e.g., bananas, oranges, apples, etc.), vegetables (e.g., carrots, pumpkins, potatoes, etc.), plants (e.g., tulips, morning glories, roses, etc.), and seasonal themes (e.g., snowmen, etc.).

In another embodiment the fibrous web substrate may also comprise embossment patterns wherein the embossment patterns and the printed graphics, G1-Gn, of the fibrous web substrates, have a predetermined association, for example such as those described in US 2004/0258886 A1, published on Dec. 23, 2004, Maciag.

The printing apparatuses and methods disclosed herein may be used offline (i.e., the printing process is a not part of a manufacture process) or used as an online process. In the offline printing process, the printed substrate may exit the printing apparatus and be wound on a roll.

In an embodiment one or more methods of controlling tension, speed and modulus, in the fibrous web substrate are utilized. For example, U.S. Pat. No. 7,092,781, issued Aug. 15, 2006, Franz et al.; U.S. Pat. No. 7,035,706, issued Apr. 25, 2006, Franz; U.S. Pat. No. 6,845,282, issued Jan. 18, 2005, Franz; U.S. Pat. No. 6,993,964, issued Feb. 7, 2006, Franz et al.; and U.S. Pat. No. 6,991,144, issued Jan. 31, 2006, Franz et al.

The following provides a test method for detecting and analyzing graphics printed in accordance with the processes and apparatuses disclosed herein with a halftone printing process.

### Test Methods

Carefully remove the printed substrate from the fibrous web substrate taking care not to deform the substrate's dimensions. Typically layers can be separated using a flash-freezing spray such as Cyto-Freeeze (Control Co. TX) or gently heating the fibrous web substrate to release the adhesives. Lay the specimen flat on a lab bench with the printed side facing up, and draw a reference line centered along the longitudinal length of the specimen. Identify a one square inch test area that includes a printed image where either 1) a color is constructed with overlapping print, where dots of at least one screen color can be discerned or 2) halftone printing where dots of the screen color can be discerned. Draw a first auxiliary line, perpendicular to the reference line, which passes through the test area. Next, place the substrate, printed side down, on the scanning surface of a flat bed scanner (for example an Epson Perfection V500 Photo scanner), close the lid and scan the identified test region at least 4800 dpi and 24-bit color depth in reflectance mode.

Examine the digital image within a graphics program such as Image J (National Institute of Health, USA). Rotate the digital image as necessary to align the first auxiliary line horizontally. Visually identify a linear arrangement of printed screen dots of a specific first color, for example 140 in FIG. 5. Using the software, draw a second auxiliary line through the center of the chosen screen dots which also intersects the first auxiliary line. To facilitate the angle measurement, the right direction of the first auxiliary line is taken to be 0° and the left direction 180°. The arc of the angle starts at 0° and arcs counter-clockwise to 180° (note all measured angles will be 180° or less). Once again, using the software, measure the angle between the first and second auxiliary lines to ±1.0 degree.

Next, an angle for a second distinct printed screen color is measured in like fashion. The second angle can be measured within the same test area, or if needed, a second test area can be chosen, scanned, and measured, following the same procedure outlined above.

Compare the angles of the two measured printed screen colors, calculating the difference between them to ±1.0 degree. Repeat the angle measurements, using corresponding test areas and colors for a least 3 fibrous web substrates. Report the average angle difference to ±1.0 degree.

Table 5 below shows exemplary data gathered using the test method described above by measuring the screen angles of ink dots printed on absorbent fibrous web substrates:

TABLE 5

| Brand | | | | | | | |
|---|---|---|---|---|---|---|---|
| Product | Printed | | | Replicates (Δ angle degrees) | | | Average |
| Size | Layer | Color 1 | Color 2 | 1 | 2 | 3 | Degrees |
| White Cloud | Film | Magenta | Cyan | 28.2 | 28.92 | 29.05 | 28.7 |
| Training Pants | Backsheet | | | | | | |
| 3T-4T | | | | | | | |
| Huggies Supreme | Nonwoven | Green | Cyan | 31.4 | 30.38 | 30.58 | 30.8 |
| Natural Fit | Cover | | | | | | |
| 3 | | | | | | | |
| Pampers | Film | Cyan | Yellow | 13.45 | 13.27 | 14.05 | 13.6 |
| Cruisers | Backsheet | | | | | | |
| 3 | | | | | | | |

### Color to Color MD Registration

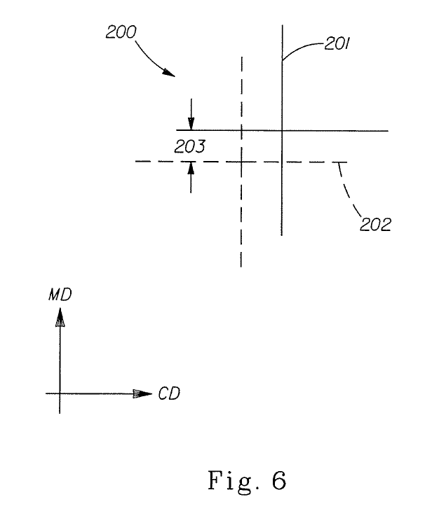

The following method is used to measure the color to color MD registration. First, the substrate samples are conditioned in a conditioned room at a temperature of 73° F. ±4° F. (about 23° C. ±2.2° C.) and a relative humidity of 50% ±10% for 2 hours prior to the test. Further, all tests are conducted in such conditioned room. All measurements are made under constant tension in the MD and CD. Lay samples out flat on a clean, dry table-top surface, minimizing stretching the substrate. Provide a substrate sample having 20 cross-hair registration marks in the MD. FIG. 6 shows an example of a cross-hair registration mark 200 having a first mark 201 (or reference mark) and a second mark 202. The first mark 201 and the second mark 202 each have a line segment in the MD that is perpendicular to a line segment in the CD. The first mark 201 originates from a printing plate or plates from a first printing station (for example 104a) and comprises a reference ink color. The second mark 202 originates from a printing plate or plates from a second printing station (for example 104b) that is sequential to the first printing station and comprises a second ink color. In an embodiment each printing plate has 1 mark. In another embodiment the first mark 201 originates from a printing plate or plates from printing station 104b, and the second mark 202 originates from a printing plate or plates from printing station 104c, and so forth. For each of the 20 cross-hair registration marks 200, measure the distance 203 between the center of the line segment perpendicular to the MD of the first mark 201 and the center of the line segment perpendicular to the MD of the second mark 202, in mm and determine the mean. This is the color to color MD registration. The line segments have an approximate width of from about 2 thousandths of an inch to about 15 thousandths of an inch. Line segments may also be dotted line segments.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is incorporated herein by reference in its entirety unless expressly excluded or otherwise limited. The citation of any document is not an admission that it is prior art with respect to any invention disclosed or claimed herein. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for printing a fibrous web substrate comprising the steps of:
feeding the fibrous web substrate onto a rotating central impression cylinder having an outer surface;
arranging a plurality of printing stations adjacent to the outer surface of the central impression cylinder, wherein each printing station comprises an endless belt with one or more printing plates disposed on or integral to the endless belt; and
advancing the endless belt to move each printing plate into contact with the substrate whereby a plurality of graphics is printed on the substrate, wherein the graphics comprise a L_{REPEAT SUBSTRATE} of at least about 58 inches.

2. The method of claim 15 comprising from about 4 printing stations to about 8 printing stations.

3. The method of claim 16 wherein each printing station further comprises a printing roller, an ink supply, and an anilox roller operably connected with the ink supply and the endless belt, wherein the anilox roller is adapted to deposit ink from the ink supply onto the printing plate(s).

4. The method of claim 15 wherein L_{REPEAT SUBSTRATE} is at least about 60 inches.

5. The method of claim 18 wherein L_{REPEAT SUBSTRATE} is from about 60 inches to about 1,500 inches.

6. The method of claim 15 wherein the substrate further comprises a plurality of discrete sheets separated by lines of termination, each sheet comprising a length, L_{DISCRETE SHEET}.

7. The method of claim 20 wherein the printing plates comprise a first lane that corresponds to a L_{FIRST REPEAT SUBSTRATE} and a second lane that corresponds to a L_{SECOND REPEAT SUBSTRATE}, and wherein the L_{FIRST REPEAT SUBSTRATE} and the L_{SECOND REPEAT SUBSTRATE} are substantially registered with the lines of termination of the discrete sheet.

8. The method of claim 20 wherein the graphics are substantially registered to the lines of termination.

9. The method of claim 15 wherein L_{REPEAT SUBSTRATE} comprises L_{FIRST REPEAT SUBSTRATE} and L_{SECOND REPEAT SUBSTRATE} wherein L_{FIRST REPEAT SUBSTRATE} corresponds to a first series of graphics and L_{SECOND REPEAT SUBSTRATE} corresponds to a second series of graphics, wherein L_{FIRST REPEAT SUBSTRATE} and L_{SECOND REPEAT SUBSTRATE} are the same or are different.
